(19) United States
(12) Patent Application Publication
(10) Pub. No.: US 2007/0143212 A1
(43) Pub. Date: Jun. 21, 2007

(54) ONLINE PRODUCT DISTRIBUTION USING FINGERPRINT AND ENCRYPTION

(75) Inventors: Lars Smith, (US); William Lipa, (US); Yugeshren Naicker, (US)

Correspondence Address: TOWNSEND AND TOWNSEND AND CREW LLP/EA, TWO EMBARCADERO CENTER, 8TH FLOOR, SAN FRANCISCO, CA, 94111, US

(73) Assignee: Electronic Arts Inc., Redwood City, CA (US)

(21) Appl. No.: 11/557,963

(22) Filed: Nov. 8, 2006

Related U.S. Application Data
(60) Provisional application No. 60/736,078, filed on Nov. 9, 2005.

(51) Int. Cl. G06Q 99/00

(52) U.S. Cl. 705/50

(57) ABSTRACT

An online product distribution method provides copyright protection and enhanced control over user access to an online product through the use of a fingerprint combined with a double encryption method that provides two layers of protection against unauthorized access to a product prior to a release date. The double encryption is carried out by using two different keys, a first key which is a customer-specific key and a second key which is a failsafe key. The failsafe key is a protection against software errors or system misconfiguration resulting in the premature release of the keys necessary for decryption. A fingerprint containing a validation code can be used for an additional level of protection. The validation code can be dynamically allocated or predetermined. In one aspect, the validation codes are embedded into the data of the online product and can provide a fingerprint which traces the product as coming from a particular source.

### CROSS-REFERENCES TO RELATED APPLICATIONS

This application claims priority from co-pending U.S. Provisional Patent Application No. 60/736,078, filed Nov. 9, 2005, entitled “ONLINE PRODUCT DISTRIBUTION USING FINGERPRINT AND ENCRYPTION,” which is hereby incorporated by reference herein for all purposes.

### FIELD OF THE INVENTION

The present invention relates to online product distribution in general and in particular to methods for distributing online computer games.

### BACKGROUND OF THE INVENTION

Computer games used to be distributed primarily through retail channels. Retail distribution would be accomplished by packaging a game CD in a jewel case and making it available for purchase on the shelves of a retail store. Since then, online purchasing and download technologies have made it possible for widespread online distribution. Online distribution provides a user with the instant gratification of being able to purchase a game and play it immediately without having to leave his computer.

In both the retail and online distribution channels, unauthorized copying is a problem which results in revenue losses to the companies that sell the games. These revenue losses can be significant if copyright pirates are able to obtain access to newly released games, copy them and distribute thousands of unauthorized copies in a short amount of time.

One approach to protect against unauthorized copying is to use digital rights management (DRM) to control distribution of media on which the computer game is provided. In retail distribution channels, disk-based protection such as Macrovision's SafeDisk and Sony's SecurROM for securing CDROM/DVD-ROM products provides such protection. In the typical disk-based approach, the build process takes the game executable and “wraps it” using vendor-specific proprietary technology. The resulting protected executable can only be run if a valid product disk (i.e., a “key disk”) is present.

For products that are sold via online purchase and download, such disk-based protection is not feasible so the digital rights management (DRM) must be implemented in a different way.

In one approach, a game executable is only operable if valid license information can be retrieved from an on-line license server. Program code within the computer game connects to an online registration server and checks a registration before allowing the game to be run. Examples of online DRM include products by PACE.

Some game distribution programs such as Steam (www.steampowered.com) provide for a pre-release download. The pre-release download allows a user to purchase a game prior to the release date, download a portion of the game at the time of purchase, and then receive the remainder of the game on the official release date by entering a special code. One advantage to this pre-release download approach from the standpoint of copyright protection is that it is impossible for the user to play the game prior to the release date because he does not have a functioning version of the game available to him.

Requiring the user to enter a special code on the release date can be a disadvantage because it requires the user to perform an additional step, i.e., the step of entering the special code. An example of this special code is the CD key printed on the jewel case of a retail version of the product, which can appear as a 13-, 20- or 25-digit serial number printed on the CD case or the manual for a game. This code is used to generate a player's unique ID code when playing the game online. In the case of Steam, each user has an individual account on Steam's system. The CD key is used as a “proof of purchase” code to grant the user's individual account access to the particular game which is associated with the CD key. Once this CD key is associated with an individual's account, the key is permanently registered and cannot be transferred to another account. Another disadvantage to this approach is that if an illegitimate user were to correctly guess and enter a legitimate key, that illegitimate user would be able to associate the key to their account and prevent the legitimate owner of the key from accessing the game. The burden would then be on the legitimate user to prove he has ownership of the key.

Distributing a portion of the game prior to the release date and distributing the rest on the release date has both advantages and disadvantages. One disadvantage to this approach is that it burdens the distribution servers on the release date. This burden arises when many users are purchasing and downloading the remainder of the product. The larger the remaining portion of the product to be downloaded on the release date, the larger the burden on the servers. If many users attempt to download the product at that same time, as can be expected on a release date, especially if the game is very popular, the increased load on the distribution servers may cause those servers to slow down significantly or possibly even to crash.

An additional disadvantage to this approach of dividing up the game into two portions is that the game company needs to decide which portion of the game to withhold from distribution until the release date. This decision can be difficult in the context of software development realities such as changes in features, timing of code freezes and the effect of bug fixes. It can also result in users being able to find ways of using the portion of code that is distributed prior to the release date. For example, if the pre-release distributed code is only missing some music or certain levels of the game, then a user might still be able to play the game despite the fact that these aspects of the product are missing. Furthermore, a user might be able to figure out how to piece together older versions of the game with the pre-release code to create a game that is newer but not the same as what the game developer intended to distribute. If the user distributes this code to others, perhaps as a knockoff copy of the game, the result can be damaging the game developer's reputation.

Once the release date arrives and the entire product is distributed to users, the product can be further distributed others, for example by software pirates. None of these solutions address the problem of tracing pirated copies of the software back to the source, that is, to the user who obtained the software through the online distribution.

Thus, what is needed is an online product distribution method which provides protection against unauthorized use and enhanced control over user access to the game prior to the release date, but which also provides a means for tracing unauthorized copies of the game back to a source or particular user.

### BRIEF SUMMARY OF THE INVENTION

An online product distribution method provides copyright protection and enhanced control over user access to an online product through the use of a fingerprint combined with a double encryption method that provides two layers of protection against unauthorized access to a product prior to a release date. The double encryption is carried out by using two different keys, a first key which is a customer-specific key and a second key which is a failsafe key. By encrypting the product using a customer-specific encryption key, the publisher can be assured that should a user gain illegitimate access through determining the decryption key, that user cannot simply distribute the decryption key for others to use. The user would be forced to either redistribute the full product, likely to be sizable, or else other illegitimate users would have to separately determine the decryption key appropriate for the download they receive from the publisher. The second failsafe key is a protection against software errors or system misconfiguration resulting in the premature release of the keys necessary for decryption. By physically withholding the failsafe decryption key from the system until it is manually made available to the system, the publisher can be assured that no customer can prematurely access the pre-release product.

A fingerprint containing a validation code can be used for an additional level of protection. The validation code can be dynamically allocated or predetermined. In one aspect, the validation codes are embedded into the data of the online product and can provide a fingerprint which traces the product as coming from a particular source by tracing the origin of the online product to a specific recipient or user who obtained the product through the online distribution.

The following detailed description together with the accompanying drawings will provide a better understanding of the nature and advantages of the present invention.

### BRIEF DESCRIPTION OF THE DRAWINGS

FIG. 1 is a flowchart illustrating a prior art process for online distribution of a software product that was obtained through retail distribution channels.

FIG. 2 is a flowchart illustrating a process for providing protection against unauthorized use of an online distributed product by downloading only a portion of the product before the release date.

FIG. 3 is a block diagram 700 illustrating a system for online distribution over the Internet 701, in accordance with the present invention.

FIG. 4 is a diagram illustrating possible implementations of fields within a fingerprint.

FIG. 5 is a flowchart illustrating a process for online product distribution in accordance with the present invention.

FIG. 6 is a flowchart illustrating a process for online product distribution in accordance with the present invention, where the user purchases the product using a credit card.

FIG. 7 is a flowchart illustrating a process for online product distribution in accordance with the present invention, where the user obtains access to the product by entering a promotional code.

FIG. 8 is a flowchart illustrating a process for online product distribution in accordance with the present invention, where the user obtains access to the product by entering an access key which is linked to a traceable source, such as the user's corporate IT account.

### DETAILED DESCRIPTION OF THE INVENTION

An online product distribution method provides copyright protection and enhanced control over user access to an online product through the use of dynamically allocated fingerprints.

According to aspects of the present invention, fingerprints are embedded into the data of the online product. In another aspect, the fingerprints can provide a means for tracing the fingerprinted product to a specific recipient or user.

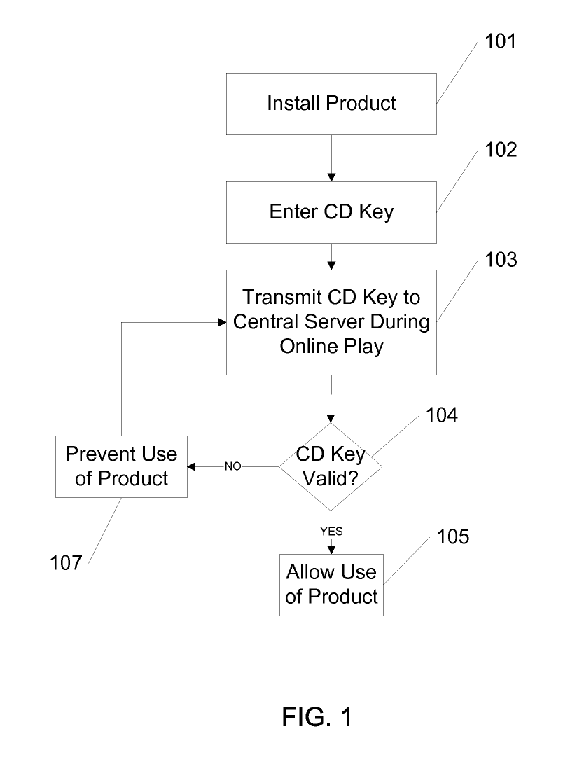

FIG. 1 is a flowchart 100 illustrating a prior art process for online distribution of a software product that was obtained through retail distribution channels. This scenario corresponds to a game purchased at a retail outlet but that is played online. A user installs the product on his console or computer, step 101. Generally, as part of the of the installation, the user is asked to enter his registration number, typically in the form of a CD key, step 102. This CD key is transmitted to a central server during online play, step 103. The central server checks the CD key that was entered against its database of CD keys, step 104. If the CD key is valid, then the user is allowed to use the product and play the game, step 105. Otherwise, the user is not allowed to user the product, step 107, and the user is denied access to the game.

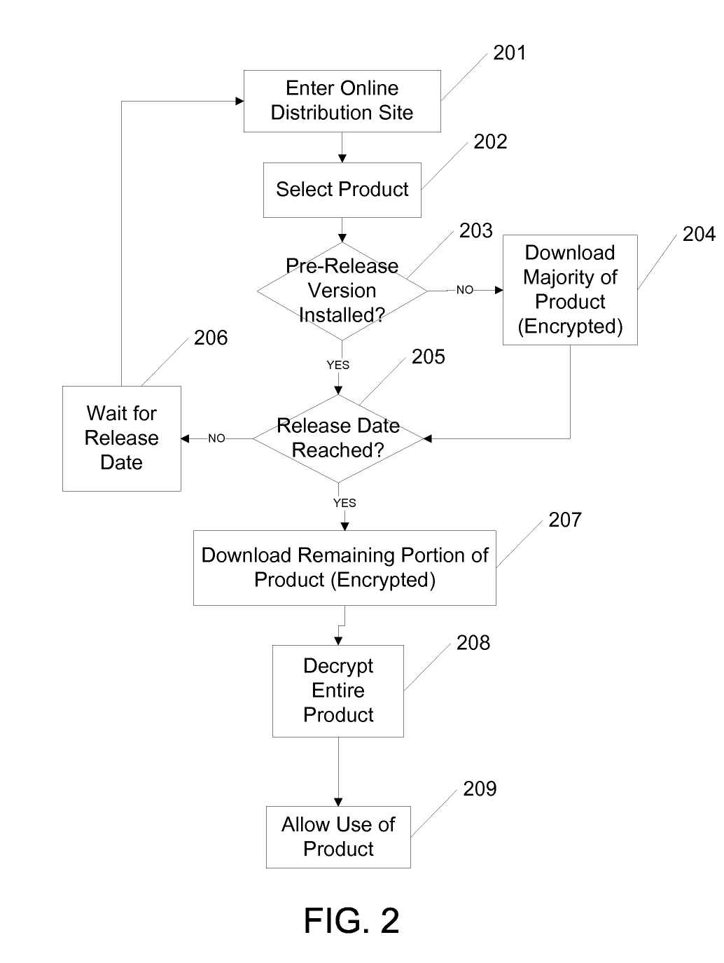

FIG. 2 is a flowchart 200 illustrating an existing process for providing protection against unauthorized use of an online distributed product by downloading only a portion of the product before the release date. A user enters an online distribution site, step 201, and selects a product that he wants to purchase, step 202. The system checks for an installed pre-release version, step 203, and if one is not found, the pre-release version is downloaded, step 204. The pre-released version of the product that is downloaded in step 204 is an encrypted version of a majority of the product that will be shipped on the release date. A portion of the product is withheld until the release date. The system checks whether the release date has been reached, step 205. If the release date has not been reached, then the user has to wait for the release date, step 206, and try later on to download the rest of the product by entering the online distribution site again, step 201, unless an automatic download at the time of the release date is set up can be carried out without the user having to initiate it.

When the release date arrives, the user can download the remaining portion of the product, step 207. The remaining portion may also be encrypted at this point. The user then decrypts the entire product, step 208, and is then allowed to use it, step 209. For example, the user is now allowed to play the newly release game.

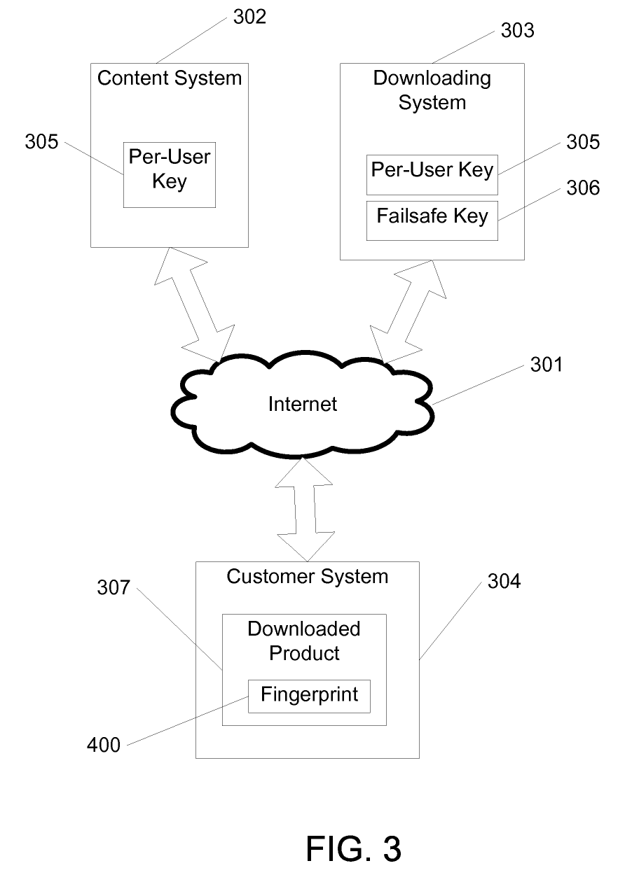

FIG. 3 is a block diagram 300 illustrating a system for online distribution over the Internet 301. In this example, the content system 302 and a downloading system 303 are shown as storing a per-user key 305 but only the downloading system 303 is shown as storing a failsafe key 306. The downloaded product (encrypted) 307 resides on the customer system 304 after the download is complete, but it is not usable because it must be decrypted with the keys that are not made available to the customer until the release date. Even if the downloaded product were decrypted, information about its source could be determined by examining the fingerprint 400.

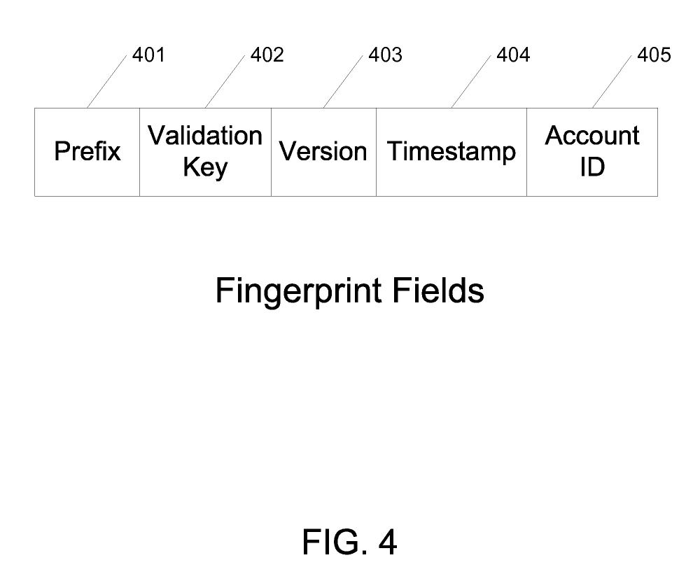

FIG. 4 is a diagram 400 illustrating possible implementations of fields within a fingerprint. The fingerprint shown in FIG. 4 supports the following fields:

A. A four character prefix <server env>OL where <server env> may be one of:
a. DV: development.
b. AL: alpha.
c. FA: fes1-alpa.
d. BE: beta.
e. PR: production.

B. A Validation Key that was used to register the product:
a. For retail builds, a fatal error occurs if there is no Validation Key for the product. The result is that the product is not downloaded.
b. Not applicable to free content such as demos.

C. The Version being downloaded.

D. The Timestamp of the download.

E. An Account ID (optional), for example an account name which may be associated with the publisher of the product.

In use, the fingerprint is decrypted and the fields are retrieved in order for the product to be made accessible. The fingerprint decryption and field retrieval may be accomplished by any means known in the art, for example, by way of a Windows application, Java application or a web page. For example, the fingerprint can be applied on the server side.

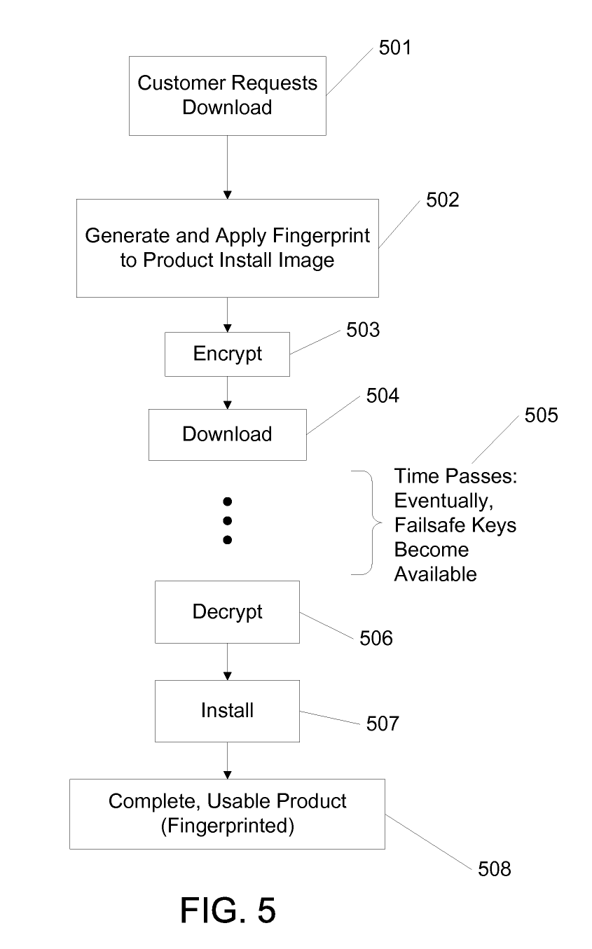

FIG. 5 is a flowchart 500 illustrating a process for online product distribution in accordance with the present invention. A customer requests a download, step 501. This customer request can be done in a variety of ways, for example, the customer could order a product using a credit card, or the customer could select a product and enter a promotional code giving him access to the product. Other possibilities include having a feature in the system which uses analytics to recommend games, content and other products that a user might be interested in based on the user's preferences (play style, titles purchased, favorite time of day to play, etc. in the case of a game player) or the user's persistent data (saved settings, saved games, saved team lists, etc.).

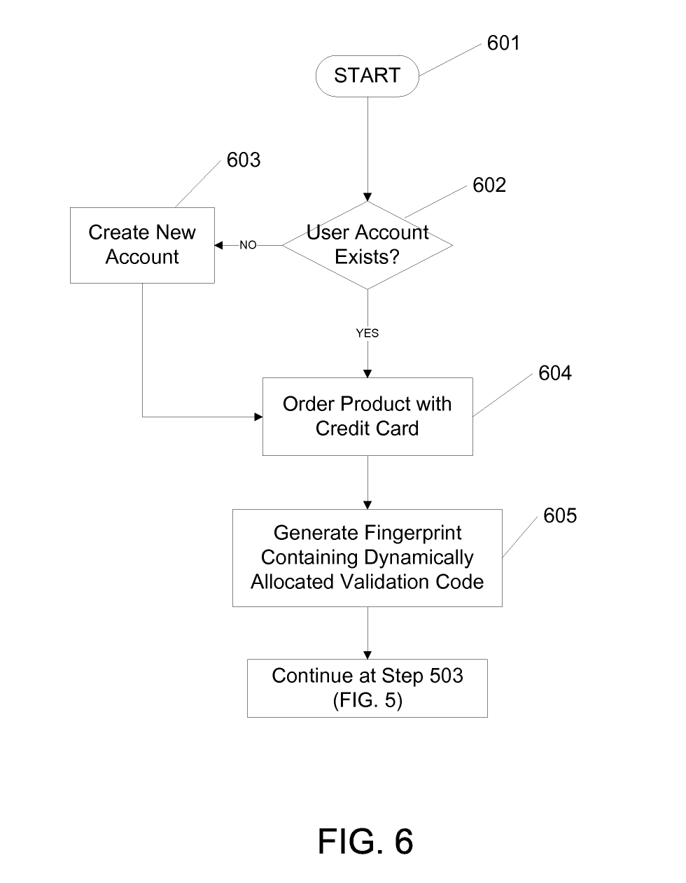

Once the download is requested, a fingerprint is generated and applied to the product install image, step 502. The fingerprint can be dynamically allocated, in which case it is never seen by the customer. It can also be created from a promotional code entered by the user. In both cases, the fingerprint can be compared to a pre-allocated list of valid fingerprints that are contained in a database on the server. The fingerprint is incorporated into the product install image in such a way as to provide a trace back to the account of the customer who requested the download. The fingerprint 400 is discussed further in the description of FIG. 4 above, and the generation of fingerprints is discussed in the description of FIGS. 6-8.

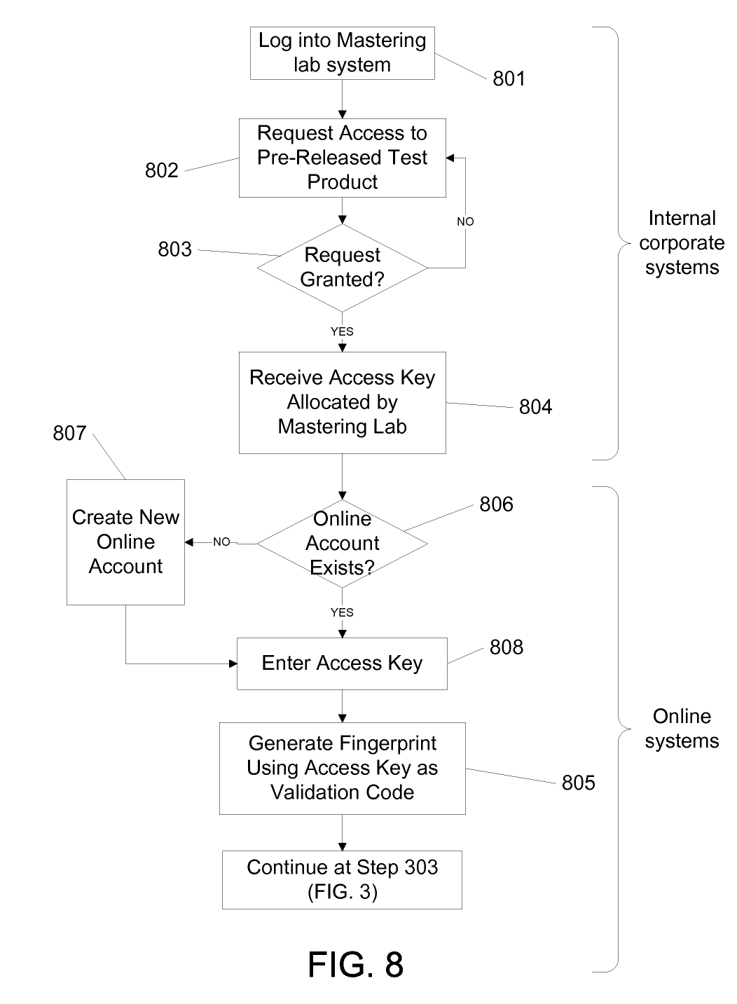

The fingerprinted image is then encrypted, step 503, prior to downloading it, step 504. The encryption is performed using two separate encryption keys, one specific to the customer and another failsafe key. The failsafe key can be a common key which is used for all customers. This encryption and downloading process occurs prior to a release date. In this particular scenario, the product is disabled until the release date. In some cases, this is not desirable, for example for testing the product prior to release. The testing scenario will be described in the discussion of FIG. 8. Time passes, 505, while the customer waits for the release date. During this time, the customer is not able to use the product.

When the release date arrives, the company distributing the product makes a failsafe key available. This failsafe key, in conjunction with the customer-specific decryption key, is required in order for the customer to decrypt the product, step 506. Once decrypted, the product can be installed, step 507. At this point, the customer has a complete, useable product that is fingerprinted in such a way as to be traceable to that customer, step 508. This tracing can be done, for example, through the credit card record of the purchase, through the customer's account on the system, or by using the promotional code that we entered during the download request. In the example of tracing the product to a promotional code, this may be used to trace the product back to the party who provided the promotional code, and not necessarily back to the specific user who entered the code.

FIG. 6 is a flowchart 600 illustrating a process for online product distribution in accordance with the present invention, where the user purchases the product by credit card. In this process, the system checks for a user account when the user goes to request the product, step 602. If the user does not have an account, then user is required to create a new account, step 603, prior to ordering the product, step 604. If the user account exists, the user can order the product with a credit card, step 604. The system receives the user's billing information through the user account and dynamically allocates a validation key. The validation key 402 is part of the fingerprint 400 which is incorporated into the downloaded product. After the generation of the fingerprint, step 605, processing continues at step 503 shown in FIG. 5.

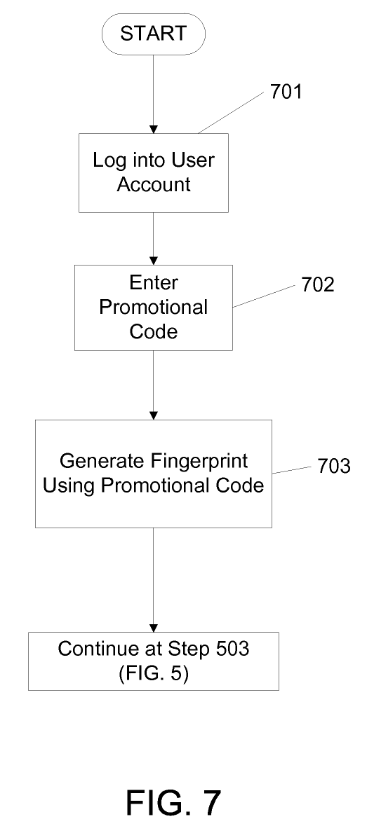

FIG. 7 is a flowchart 700 illustrating a process for online product distribution in accordance with the present invention, where the user obtains access to the product by entering a promotional code. In the example, it is assumed that the user has an account, has logged into the account, and has selected a product to download. The user enters a promotional code, step 701. This validation key 402 provides a means for tracing the product installer image to the promotion code that the user entered. This is useful for tracing the download of the product to the party who provided the promotional code. For example, sales and marketing organizations often provide such codes to allow prospective buyers gain access to a product. In this case, even though the promotional code was given, the user still cannot unlock the product until the release date because he needs to have both the per-user key and the failsafe key in order to decrypt the product. A fingerprint 400 is generated using the promotional code, step 703. After the generation of the fingerprint, step 703, processing continues at step 503 shown in FIG. 5.

FIG. 8 is a flowchart 800 illustrating a process for online product distribution in accordance with the present invention, where the user obtains access to the product by entering an access key which is linked to a traceable source, such as the user's corporate IT account. The flowchart is shown as being partially performed in the context of internal corporate systems and partially performed in the context of online systems. In this example, a user (hereinafter referred to as a “tester” for purposes of this example) logs into an internal corporate account, in this case the Mastering Lab system, step 801. The tester requests access to the pre-released test product, step 802, in order to do testing. An organization with authority to grant access to the product, for example a mastering lab, decides whether to grant access to the tester, step 803. The tester receives an access key which has been allocated by the Mastering Lab, step 804. The access key is linked to the information associated with his corporate IT account (which includes the tester's name, supervisor, title, phone number, employee number, etc.).

If the tester does not have an online account, step 806, then he must create a new online account, step 807. Once the tester logs into this online account, he can enter the access key, step 808. This access key is used to generate a fingerprint 400, step 805, using the access key as the validation code 402. The fingerprint is used to associate the downloaded product with the tester's account through the allocated access key. If the tester were to pass along the image to another party, the company would be able to trace the image as coming from the particular tester by looking at the fingerprint on the image. After the fingerprint is generated, step 805, processing continues at step 503 shown in FIG. 5.

While the invention has been described with respect to exemplary embodiments, one skilled in the art will recognize that numerous modifications are possible. For example, the processes described herein may be implemented using hardware components, software components, and/or any combination thereof. Thus, although the invention has been described with respect to exemplary embodiments, it will be appreciated that the invention is intended to cover all modifications and equivalents within the scope of the following claims.

What is claimed is:

1. A method for online product distribution, comprising:
determining a validation key associated with an entity;
generating a fingerprint associated with said entity;
associating the fingerprint with a product to be downloaded, wherein the downloaded product can be traced to the associated entity;
encrypting a product using a per-user key and a failsafe key, wherein the failsafe key is unavailable until a predetermined time; and
decrypting the product using the per-user key and the failsafe key, wherein the failsafe key is physically unavailable to the customer until a predetermined time.

2. The method of claim 1, wherein the entity is a user having an account with access to online product distribution.

3. The method of claim 1, wherein the entity is a provider of a promotional code.
